(19) United States
(12) Patent Application Publication
(10) Pub. No.: US 2016/0140244 A1
(43) Pub. Date: May 19, 2016

(54) SYSTEMS AND METHODS FOR CONNECTING NATIVE LANGUAGE SPEAKERS AND SECOND LANGUAGE LEARNERS ACROSS A NETWORK

(71) Applicant: Boomalang Company, Nashville, TN (US)

(72) Inventors: Chris Gerding, Nashville, TN (US); Leiya Hasan, Nashville, TN (US); Justin Gifford, Nashville, TN (US)

(21) Appl. No.: 14/831,344

(22) Filed: Aug. 20, 2015

Related U.S. Application Data
(60) Provisional application No. 62/039,761, filed on Aug. 20, 2014.

(51) Int. Cl. G06F 17/30; H04L 29/06; H04L 29/08

(52) U.S. Cl. CPC G06F 17/30867; H04L 67/141; G06F 17/30896; H04L 65/403; G06F 17/30528

(57) ABSTRACT

A method is described herein including a plurality of client applications providing an electronic interface for receiving personality information and conversation preference information of corresponding users, wherein each client application of the plurality of client applications runs on a corresponding computing platform. The method includes one or more applications running on a processor of a remote server receiving the personality information and conversation preference information from the plurality of client applications, the one or more applications using the personality information and conversation preference information to match a first user of a first client application with a second user of a second client application. The method includes the one or more applications establishing a communications coupling between the first client application and the second client application, wherein the communications coupling comprises a communication session.

### CROSS REFERENCE TO RELATED APPLICATIONS

This application claims the benefit of U.S. Application No. 62/039,761, filed Aug. 20, 2014.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Modern society is inherently international. Economic business relationships and global travel increasingly bring different cultures and different language speakers into contact. Multinational companies increasingly hire associates and executives that can speak another language and understand another culture. Accordingly, language and translation services are in top demand providing growth opportunities for industry and startups. However, many language learners still lack an opportunity to improve their speaking fluency.

### BRIEF DESCRIPTION OF DRAWINGS

FIG. 1 shows a front end screen of the Boomalang platform providing an option to login or sign up under an embodiment.

FIG. 2 shows a screen allowing a user to edit profile data under an embodiment.

FIG. 3 shows a screen allowing a user to edit profile data under an embodiment.

FIG. 4 shows a series of user selections which facilitates matching Boomalang users under an embodiment.

FIG. 5 shows a series of user selections which facilitates matching Boomalang users under an embodiment.

FIG. 6 shows a dashboard featuring a map and icons representing Boomalang users in their respective geographic locations under an embodiment.

FIG. 7 shows a screen allowing two Boomalang users to vote for a topic of conversation under an embodiment.

FIG. 8 shows a screen indicating the Boomalang platform connecting users under an embodiment.

FIG. 9 shows a live video chat session under an embodiment.

FIG. 10 shows part of an on-ramp questionnaire interface, under an embodiment.

FIG. 11 shows part of an on-ramp questionnaire interface, under an embodiment.

FIG. 12 shows part of an on-ramp questionnaire interface, under an embodiment.

FIG. 13 shows part of an on-ramp questionnaire interface, under an embodiment.

FIG. 14 shows part of an on-ramp questionnaire interface, under an embodiment.

FIG. 15 shows mobile devices coupled to a remote server, under an embodiment.

### DETAILED DESCRIPTION

Boomalang connects native speakers from different cultures to improve conversational skill in their respective second languages. Systems and methods for connecting such native speakers are described herein.

### Peer-to-Peer Virtual Immersion

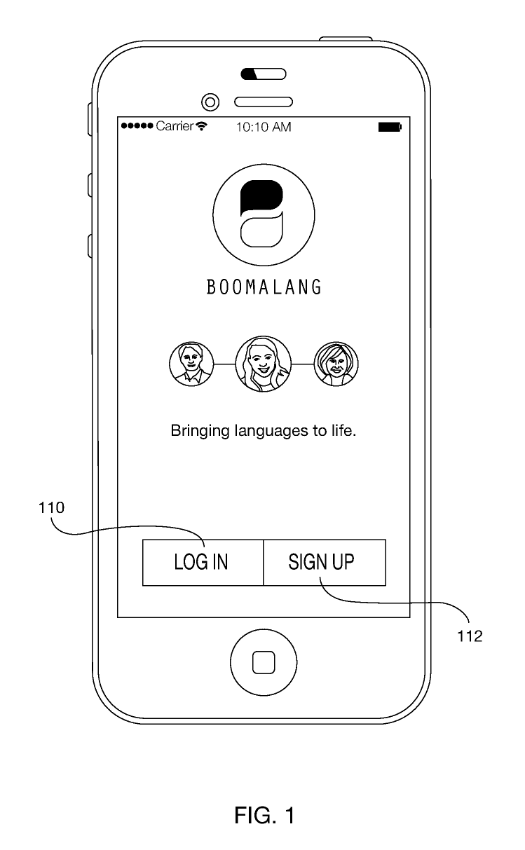

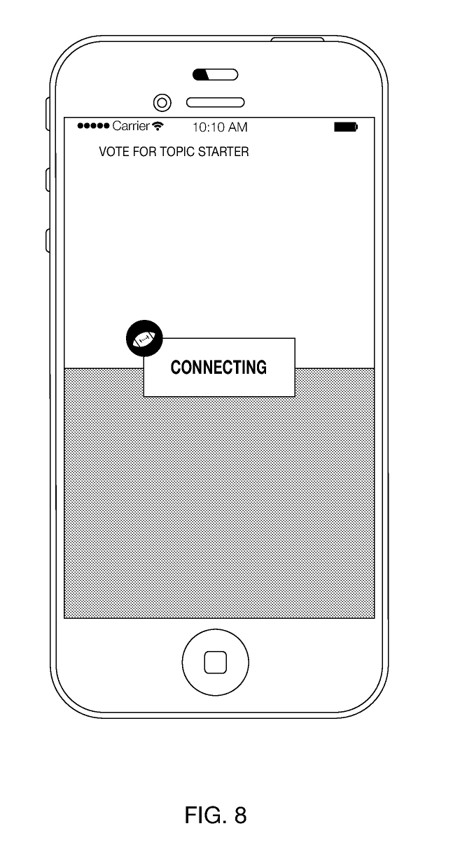

The Boomalang platform (described in greater detail below) matches native speakers of different languages to provide real time conversational exchanges that mutually increase second language conversational ability. Boomalang provides a language/culture exchange platform that breaks down the traditional roles of the language tutor and the language student. Boomalang provides a true exchange of native conversational abilities between language learners. Rather than distinguish between tutor and student, Boomalang comprises a language/culture exchange platform, connecting native speakers from across the world to improve cultural competency and conversational fluency in desired second languages. FIGS. 1-9 show the Boomalang platform implemented on a smartphone. However, it should be understood that the Boomalang application may be multiplatform, available on smartphones, tablets, laptops, desktop computers, smart televisions and gaming consoles.

The Boomalang platform matches native speakers and language learners based on certain matching criteria. Under one embodiment, a level of second language proficiency is itself part of the match selecting criteria. As one example, a user of the Boomalang platform may self select into “Beginner,” “Intermediate,” or “Advanced” exchange levels based on level of language ability. Under one embodiment, the platform may further sub-tier skill levels within the beginner, intermediate, and advanced categories. Due to the fact that the Boomalang process matches two native speakers with respective (or reciprocal) second language interests, there is a mutual exchange of learning regardless of selected levels. As part of the platform, a “Boomalang language bar” visible to both connected users during a chat session designates when it is appropriate to be speaking in only a first language. The language bar may automatically switch to a second language every 15 minutes, encouraging the 2 conversationalists to alternate between a first and second language. As just one example, the first language may be English while the second language may be Spanish. Of course embodiments are not so limited, and the Boomalang platform accommodates under one embodiment nearly any spoken language so long as native speakers are available to and registered with the Boomalang platform. It should also be noted that the fifteen minute interval is arbitrary and that Boomalang users may elect to speak exclusively in one language or alternative languages at various intervals. Further, the conversation or exchange may be one-on-one or multiuser under alternative embodiments.

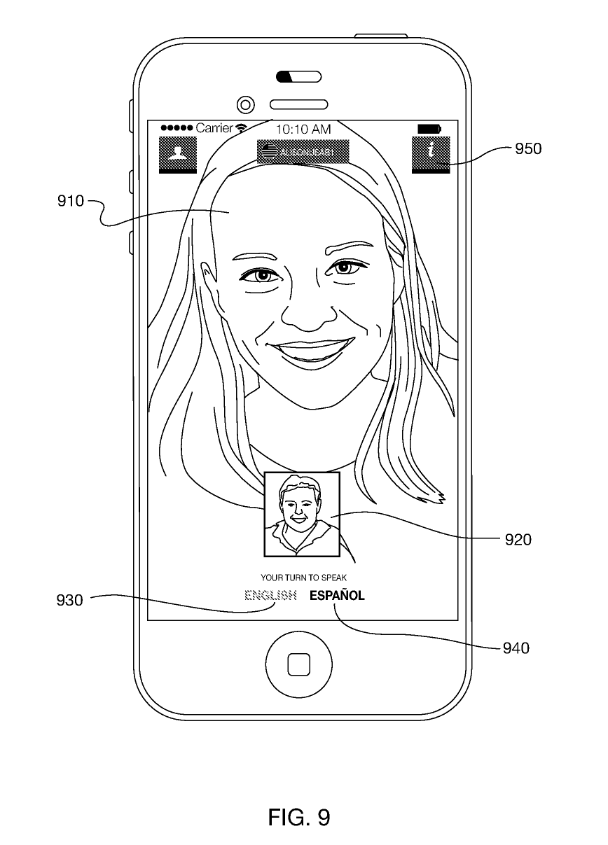

FIG. 9 shows an active communication session between Boomalang users 910, 920, under one embodiment. The bottom of the figure shows the language bar comprising English 930 and Español 940 indicators. In this FIG. 9, the Español tab 940 is highlighted indicating that the users are instructed to speak English.

### Matching Speakers

As indicated above, Boomalang provides an online application that connects foreign language speakers across a networked platform. Under one embodiment, Boomalang users first register with the service. FIG. 1 shows a screen providing a user an option to login 110 to the platform or sign up 120 for the service. Users may supply the following information or perform the following steps as part of the registration process or generally as part of using the Boomalang platform, i.e. through continuously available user profile edit options:
A user fills out profile information to have access to the network of users under an embodiment. A user may initially be directed to provide ‘simple profile information’ under an embodiment including first name, last name, email address, username, and password. A user may provide such information on one screen using a series of input boxes and/or drop down menu selections.
A user is directed to select/indicate additional demographic data under an embodiment including Age, Gender, Country, State or Province, Native Language, and “I Want to Improve My” (followed by a drop down menu of language options), and “Current Level” (followed by “Beginner,” “Intermediate,” or “Advanced” options). The Boomalang platform may offer Spanish, Arabic, and English language options but embodiments are not so limited.
A user uploads a profile photo under one embodiment and additionally uploads an audio recording or video introducing themselves as a matter of virtual introduction. Such recordings or video may be limited to 45 seconds under one embodiment.

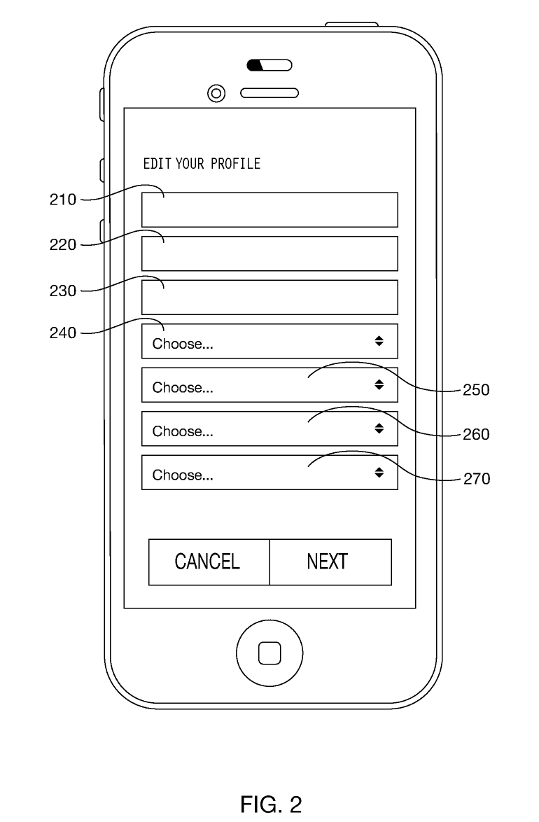

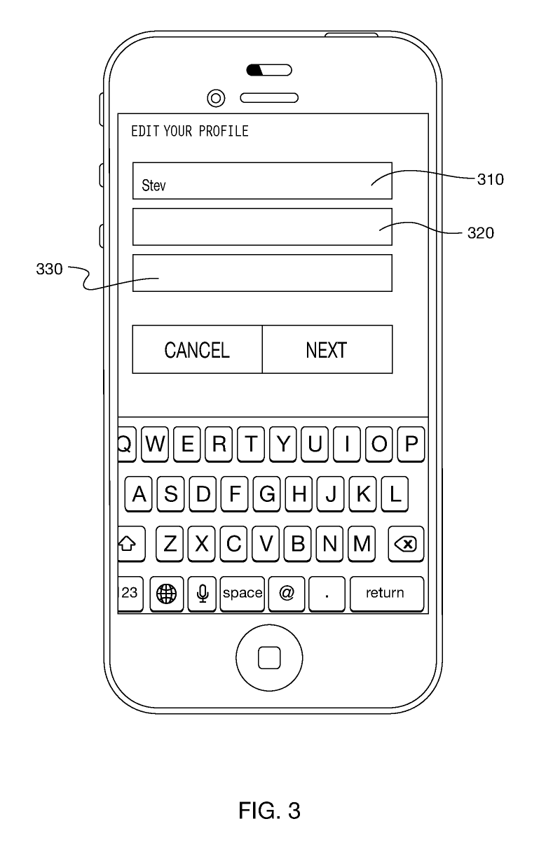

A user may later edit his or her profile information. FIGS. 2 and 3 show application screens allowing a user to edit profile information including first name 210, last name 220, and email address 230. FIG. 2 also provides drop down menus allowing a user to specify/change country selection 240, state/province section 250, “I want to learn” language selection 260 and “I want to teach” language selection 270. FIG. 3 shows a screen for editing first name 310, last name 320 and email address 330 under an embodiment.

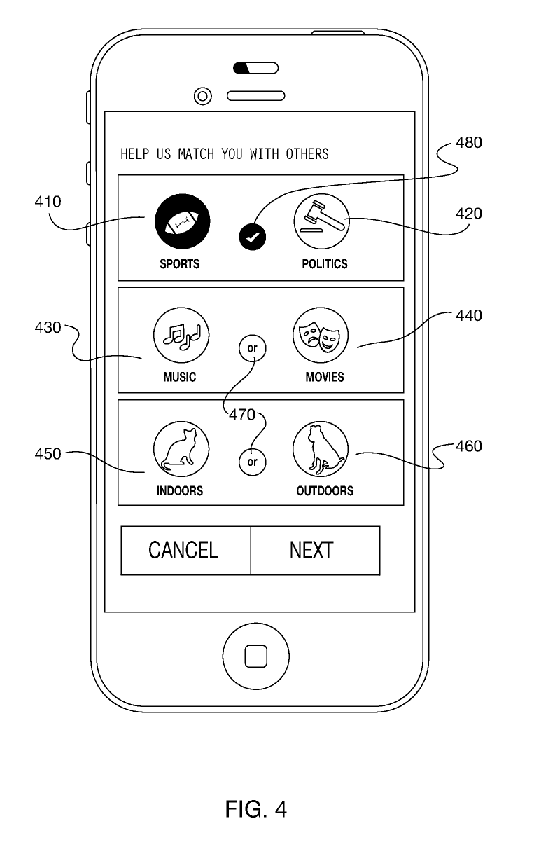

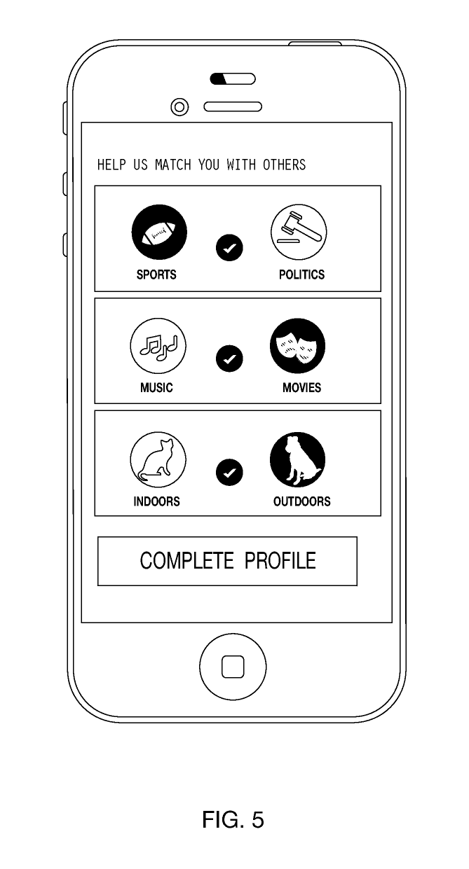

Under one embodiment of the Boomalang platform, a user may provide certain preference information in order to facilitate a match with a conversation partner. For example, a Boomalang interface may provide pictorial “A or B” options to a user. As seen in FIGS. 4 and 5 the user may be provided with a series of three such “A or B” pictorial options—e.g., sports 410 or politics 420; indoors 450 or outdoors 460; movies 450 or music 440. These options may be presented as words and images which clearly represent the underlying concept (e.g. a picture of a football together with the word sports and a picture of music notes together with the word music). User choices/selections allow Boomalang to identify optimal conversational partners, and equally importantly, which content categories to push them for discussion “ice breakers.” As shown in FIGS. 4 and 5, each set of options is separated by an “or” 470 designation. As a user selects the “A” or the “B” option, the screen replaces an “or” separating the choices with a check mark 480. FIG. 4 shows that the user has selected sports 410 over politics 420 and has yet to make any additional selections. FIG. 5 shows a completed set of “A or B” selections as previously presented in FIG. 4.

These “A or B” selections comprise a series of three (3) “A or B” choices and may be presented to a user upon login. Under one embodiment, a new series of three “A or B” choices are available to a user each time the user logs into the Boomalang platform. Accordingly, the more use, the more profile information may be gathered about each user thereby enabling more optimized matching. User answers are under one embodiment logged and may be changed by the user if so desired. As an example, a user may click “profile history” at any point and view their historical responses for A versus B options. If they'd like to be paired based on choosing politics instead of football (when the user had previously selected the opposite), a user may change the prior selection. Accordingly, Boomalang's optimization of possible language partners based on user “A or B” choices is adjusted accordingly under an embodiment.

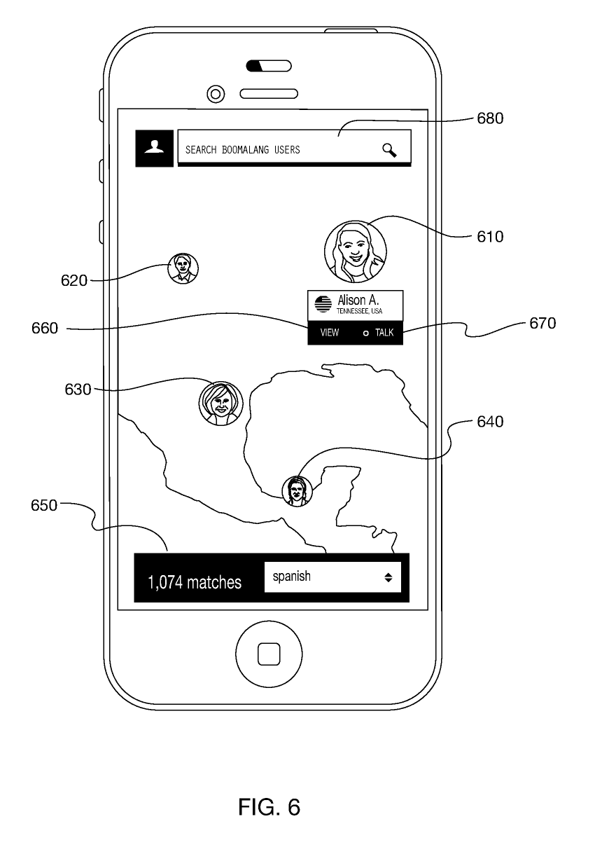

Under one embodiment, a user logs into the Boomalang platform and completes a series of 3 “A or B” questions during the log-in process. After completing the selections, user views a global map (as seen in FIG. 6) showing thumbnail pictures of other Boomalang users 610, 620, 630, 640 that are native speakers of the language the user wishes to practice. The thumbnails are under an embodiment located on the map where Boomalang users are geographically located in person. The better the match, the larger a corresponding thumbnail may appear. In other words, matches with a higher probability of compatibility may appear as larger thumbnails in order to highlight or emphasize optimal matches. FIG. 6 shows a map featuring thumbnail pictures of Boomalang user matches. Each such thumbnail is approximately positioned where such user is geographically located. Note that FIG. 6 shows 1,074 possible matches at the bottom left 650 of the screen. Under an embodiment, the screen only shows matches that achieve a threshold level of compatibility. Further a user may also be able to filter and therefore reduce the number of displayed matches as further described below.

The Boomalang platform optimizes matches using an automated algorithm. Under an embodiment, the automated algorithm may use all of the aforementioned profile information/demographic data and “A or B” selection data. The automated algorithm may assign “A or B” pictorial options various weights. Users may be given an opportunity to weight selections themselves using Likert scales or any other type of rating scale. Further, the automated algorithm may observe user selections over time and identify preferences based on trends. For example, a user may consistently select repeated athletic oriented choices over alternatives. Based on this trend, the automated algorithm may assign athletic oriented choices a greater weight. The automated algorithm then ranks potential matches based on a probability of a broader set of common preferences and dislikes. Again note that FIG. 6 shows 1,074 possible matches at the bottom left 650 of the screen. Under an embodiment, the screen only shows matches that achieve a threshold level of compatibility based on the automated algorithm's ranking.

The possible matches may also be filtered by the user based on a number of criteria, i.e. a user may place more weight on certain categories/preferences over the others. For example, a user may filter match results by selecting a “Gender>Male” filter. The selection filters the match results to males only. Accordingly, only males will remain on the screen. If a user selects to filter by “age 20-30” category, the user may eliminate those matches outside of this age range for their dashboard. The size of the thumbnails may change as the filter choices change. As indicated above, the larger the thumbnail, the better “fit” a match represents under one embodiment.

Under one embodiment, a user may view a dashboard screen including global map featuring icon representations of potential matches as the user applies filters. Under another embodiment, they may reach such dashboard after applying filters. When viewing a dashboard a user may click on a thumbnail of an individual the user would like to contact. Upon such selection, a “View” option 660 becomes available, where a user may view the ‘simple profile information’ of a matched individual, along with a profile picture, should the user have chosen to upload a photo (and audio/video introduction) and if such content is available for viewing.

In addition to a “View” option 660, a user may also see a “Talk” button 670. A green circle may appear next to the word if a corresponding user is currently online. If the user touches the “Talk” button in this instance, the selected user may receive a ring alert on his or her screen providing notice that a fellow “Boomalanger” is trying to connect. Clicking “accept call” on the receiving end engages the computer/device to prompt an “enable microphone and video share” alert. Once both users accept the audio/video share, both users then engage in a live video chat, where they see each other, as well as themselves on the screen. FIG. 9 shows an example of a live video chat under an embodiment. Additionally, the users under one embodiment see an indicator (as mentioned earlier) displaying which of two languages should be spoken. FIG. 9 shows such an English/Español indicator at the bottom of the screen. The Boomalang platform may automatically alternate the “active” language selection every 15 minutes. Additionally, the users may also see an “i” inspiration button in the top right part of their screen as described in greater detail below.

If a user thumbnail does not have a green circle next to the “Talk” indicator, then the circle is simply empty. An empty circle means that the user is not currently signed into the application. If this is the case, a user (that is currently online) can still click the “Talk” button, which will direct him/her to a page of available times that that other person plans on being online. (A user may maintain such “availability” data as part of user's profile under an embodiment). Furthermore, a user may click “I′d like to practice with you!” This selection triggers delivery of this message via email to the selected user. Of course, a user may select whether a user wishes to receive such emails and may disable such feature if so desired under an embodiment.

### Content Guidance/Ice Breaker Material

In addition to matching language proficiency capabilities and user preferences, Boomalang may also provide a unique system of conversation direction/guidance in a number of ways.

As mentioned earlier, when logging in, a user may answer 3 quick questions (via the “A” or “B” model). This process not only builds an accumulated profile history, enabling more optimal matching over time, but also generates social cues for conversation topics. Once two users are connected for live conversation, they may each be prompted with a series of “A or B” questions until the users agree upon a selection. These “live session” questions may be completely different than those presented to each user upon login. However, the “live session” questions are the same for the two users who are connected for live conversation under one embodiment.

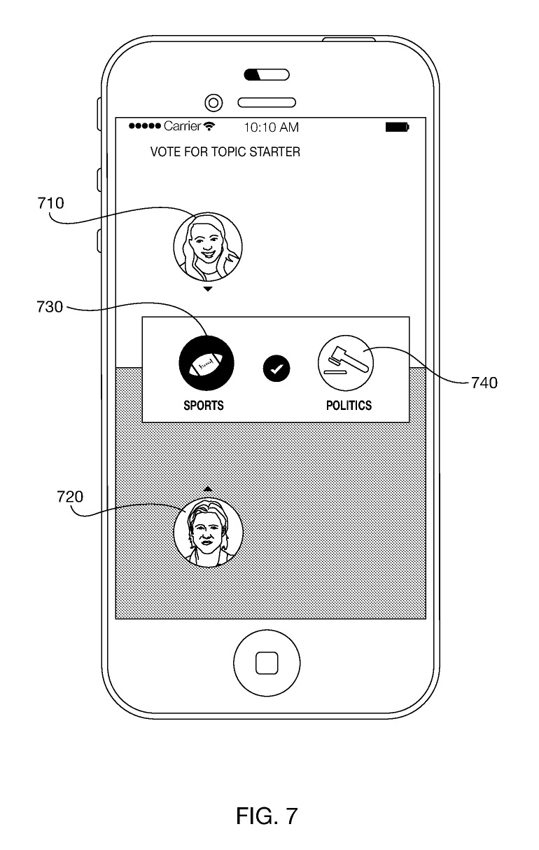

When presented with these “live session” questions, each user independently makes his/her selections based on what the user would like to discuss. Each user performs this “A” or “B” selection for the three questions. As seen in FIG. 7, users 710, 720 have agreed upon sports 730 over politics 740. Once there is an agreement (which may require a few iterations of “A or B” question sets), they then engage in a live video (or audio-only) chat session and discuss the mutually selected topic. If a user prefers initial privacy, the user may enable audio share only, and then graduate to video share once a user feels more comfortable. Text chatting capabilities may only be allowed during a call or audio chat under one embodiment.

Once a conversation begins between connected “Boomalangers”, there will be an “i” inspiration button 950 at the top right of each user's screen as seen in FIG. 9. The “i” may be available to both parties at all times during a conversation session under an embodiment. If a user click the “i” button, one of two events may occur: both users either see a prompt for discussion/debate, or the users each view a common video clip in real time. Under one embodiment, content for both options may be randomized. Under a preferred embodiment, such content is related to information provided by the users in their profile creation/editing/refinement, i.e. the video may be a clip from a Harry Potter film if both users selected ‘fictional film’ in an “A” or “B” scenario earlier. Note that this form of content selection presents material based on both users' preferences.

The ‘inspiration’ prompts for discussion/debate are under an embodiment similar to the “A or B” pictorial questions described above, but more specific. Under one embodiment, a question may appear along with two choices. For example, “Who will win the next golf Major between the two following options?” The following answer choices “Tiger Woods” and “Rory McIlroy” also appear under such embodiment. The question and the corresponding answer choices “inspire” conversation between the connected Boomalang users.

Any time either user presses the inspiration button, both users are prompted to see the next discussion/debate question or video content under an embodiment.

### Games

Beyond topical information related to user interests/behaviors, there may also be provided gamified applications of the “inspiration” function described above. When users mutually agree to a game, they'll have a number of options. Each such game may be rolled out to market independently. Such games may be rolled out in the form of a “game of the month” as a way to boost user retention and increase user activity.

The Boomalang platform may provide the following games
“Charades”—Just like the classic game with which everyone is familiar. During a Boomalang brokered conversation, one user's screen may present a scenario/term to the user who may then act it out to the other user who guesses answers in real time during the conversation session.
“Person Place or Thing”—Similar to Charades, the Boomalang application may show a person/place/thing on one user's screen. The user may then be required to describe the person/place/thing without using a few listed key (obvious/revealing) words. Once the matched user/partner guesses the person/place/thing correctly, it becomes the other person's turn.
“Spot the difference”—This game provides under one embodiment a live competition where each user chimes in with his or her observations of what elements are different in a series of two photos. Each pair of photos may have 5 differences but embodiments are not so limited.
   The Boomalang application may incorporate categorical vocabulary topics into such games. As just one example, the category (“kitchen/cooking”) may be of interest. Such category may then influence or define the content categories found or provided in all of the above referenced games. Of course, the Boomalang application and platform may provide any number of games in addition to the ones described above.

### Privacy

Privacy is paramount to the Boomalang platform and its users. As already described above, users may elect audio-sharing-only options. Further, users are also able to report inappropriate behavior from other users under an embodiment. Furthermore, users are able to block other users who are then “invisible” to the blocking user. Conversely, users may also be able to add matches they enjoy to a “Boomalang Buddy” list so long as enlisted buddies accept (or configure their profiles to accept) such requests. This way, users may reconnect via Boomalang in the future without having to seek each other out. Additionally, there is a Boomalang search feature. For example, a user may recommend a buddy as a good match for another Boomalang user. Under an embodiment, a user may then search the recommended user name in a search bar and contact them directly, rather than relying on matching with them on the user dashboard full of thumbnails. FIG. 6 shows an example of a search bar 680 at the top of the screen.

### Text Chatting

During a conversation session, there is a translation box available under one embodiment that provides a unique/private communication channel between connected users. Under one embodiment, the texting can be auto-translated into a language of choice as determined by a user or collectively by connected users. Under one embodiment, a user may type into a texting or “translation” box which functions as a dictionary. The Boomalang platform may log entered terms, words, and/or phrases. As just one example, the Boomalang platform logs the fact that a user has asked the dictionary to translate the word “house” four times, The user may view his or her word history to identify these repeat translation requests and to highlight practice areas. The Boomalang platform may also use this data to tailor content/game material towards these words to help the user improve upon problem areas.

As indicated above, language learners often lack opportunity to improve speaking fluency. Boomalang connects native speakers from different cultures to improve conversational skill in their respective second languages. Language learning trends are moving away from formalized training towards effective communication, and e-language learning technology is soaring. In addition to the academic sector, there's momentum in the corporate space. Multinational companies are hiring associates and executives that can speak another language and understand another culture.

“Unlocking cultural competency through the tool of spoken language.” Boomalang provides a medium for creating connections. Ultimately, Boomalang strives to promote tolerance and better global citizenship by providing avenues for individuals to understand the beauty of the different languages and cultures around us.

As described above, an intermediate language learner registers with Boomalang by entering their profile information. Boomalang provides them with their best matches and trending topics communities. Under one embodiment, the Boomalang platform matches users based on trending topics identified via social media (e.g. twitter trends). Under such embodiment, a dashboard presented to a user may show Boomalangers who are interested in discussing a certain trending topic.

Under one embodiment, a first time user may choose a subscription plan. Once enrolled, users can engage in real time peer-to-peer video conversation.

Effective communication is central to today's globally connected world. Speaking fluency in more than one language affords individuals greater mobility and career advancement opportunities. On average, pay differentials can range from 5 to 20 percent more per hour for bilinguals. Boomalang provides a platform for peer-to-peer conversation around mutually relevant content.

### On-Ramp for Profile Creation.

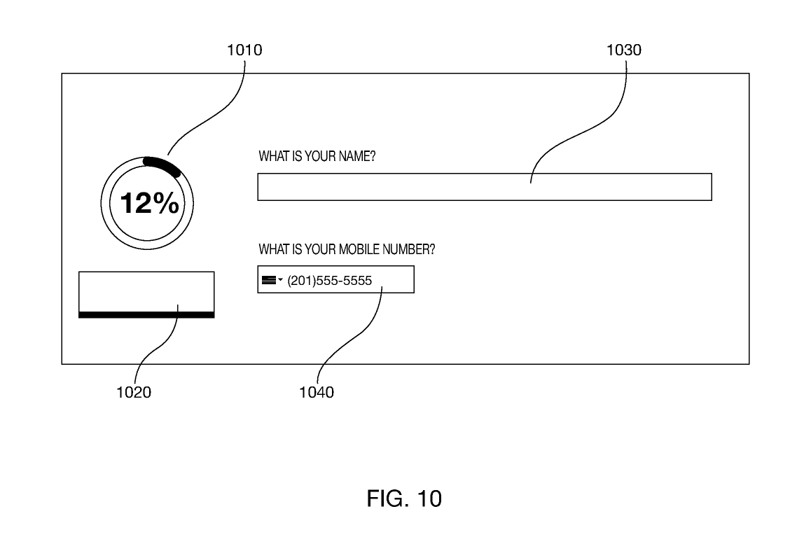

FIGS. 10-14 illustrate the 15 steps a new user must take in order to create a profile under one embodiment. This is under such embodiment a pre-requisite to using the Boomalang platform, serving two functions:
Providing Boomalang with information necessary to match the user with his/her most compatible speaking counterpart(s).
Providing Boomalang with information that will influence the type of “ice-breaker” content that is served to the matched pair, whether in the form of questions (i.e. “Who is your favorite character in Harry Potter.”) as well as more elaborate games (i.e. “Describe this character to your partner without using the words “Harry” “Potter” “protagonist” or “main character.”)

FIGS. 10-14 illustrate the steps of the on-ramp questionnaire over a series of five interface panels. FIG. 10 simply requests the user's name 1030 and mobile number 1040. FIG. 10 shows a completion circle graphic 1010 indicating 12% completion of the process. FIG. 10 also provides tab 1020 either indicating the number of questions remaining and/or an option to save and continue the process.

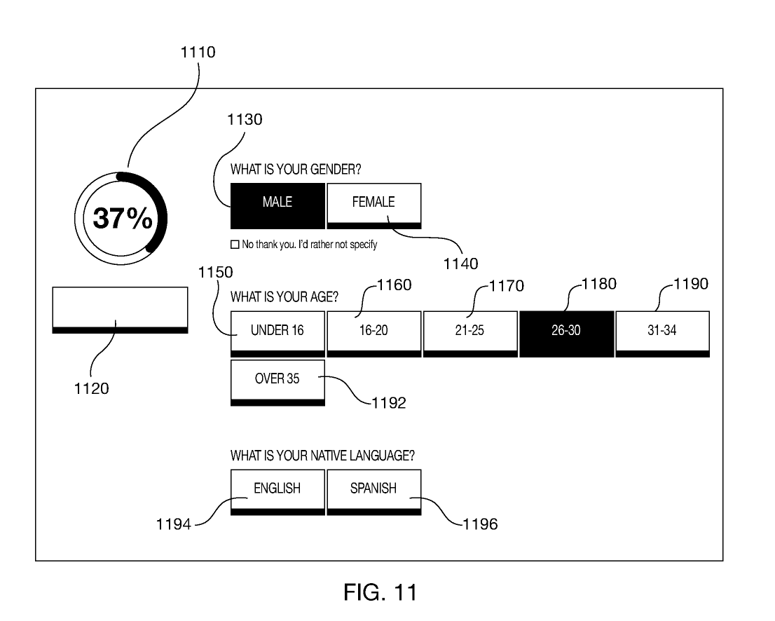

FIG. 11 shows a screen requesting gender: male 1130, female 1140. FIG. 11 also shows a screen requesting selection of an age grouping: Under 16 (1150), 16-20 (1160), 21-25 (1170), 26-30 (1180), 31-34 (1190), Over 35 (1192). FIG. 11 shows a screen requesting the user's native language. Under this embodiment, the user has a choice between English 1194 and Spanish 1196. Additional embodiments may add language selections according the geographic/demographic attributes of platform users. FIG. 11 shows a completion circle graphic 1110 indicating 37% completion of the process. FIG. 11 also provides tab 1120 either indicating the number of questions remaining and/or an option to save and continue the process.

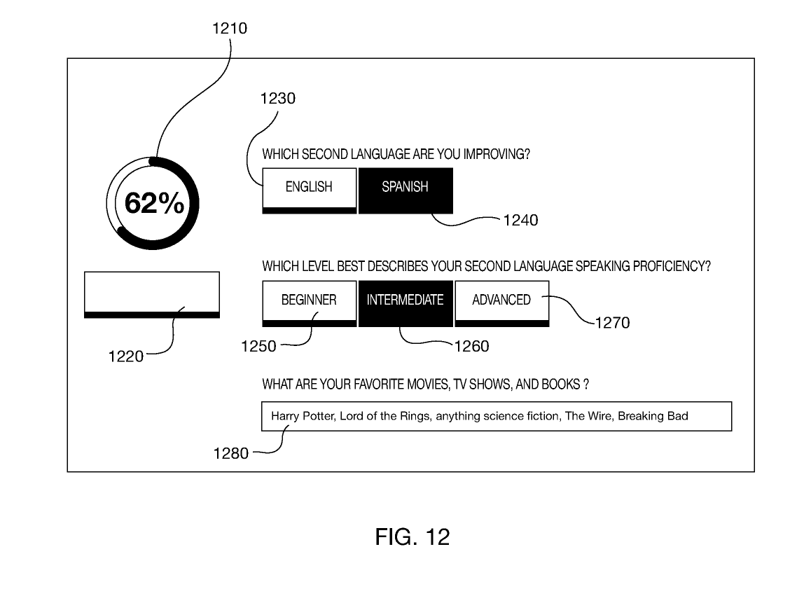

FIG. 12 shows a screen requesting user to indicate which second language the use wished to improve: English 1230 or Spanish 1240. The display of FIG. 12 also requests indication of second language skill level: Beginner (1250), Intermediate (1260), or Advanced (1270). The screen shown in FIG. 12 also request entry of favorite movies, TV shows and books into given text box 1280. Here the user indicates, Harry Potter, Lord of the Rings, anything science fiction, The Wire, and Breaking Bad. It is understood that such interface may provide separate input regions for entry of movie selections, TV show selections and book selections. FIG. 12 shows a completion circle graphic 1210 indicating 62% completion upon user submission of the requested information. FIG. 12 also provides tab 1220 either indicating the number of questions remaining and/or an option to save and continue the process.

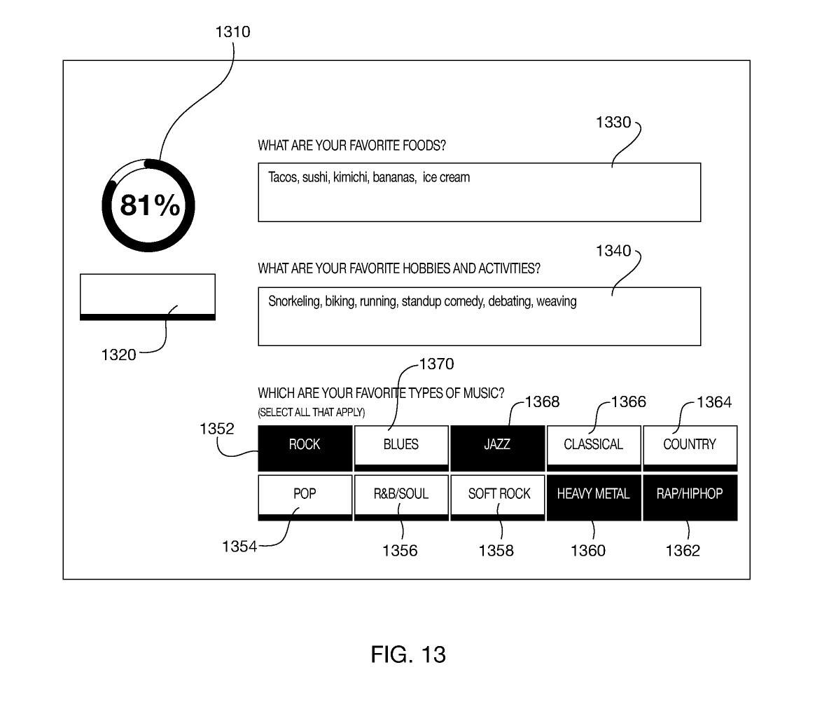

FIG. 13 shows a screen requesting information regarding favorite foods. The user may input favorite foods into text box 1330. As shown in the figure, the user has indicated tacos, kimchi, bananas, and ice cream. FIG. 13 also shows a screen requesting information regarding favorite hobbies and activities. The user may input favorite hobbies and activities into text box 1340. As shown in the figure, the user has input snorkeling, running, standup comedy, debating, and weaving. FIG. 13 further requests user's indication of musical preferences through selection of one or more tabs. The presented tabs include rock 1352, blues 1370, jazz 1368, classical 1366, country 1364, pop 1354, R&B/Soul 1356, soft rock 1358, heavy metal 1360, and rap/hip-hop 1362. The user has selected rock, jazz, heavy metal and rap/hip-hop. FIG. 13 also shows a completion circle graphic 1310 indicating 81% completion of the process. FIG. 13 also provides tab 1320 either indicating the number of questions remaining and/or an option to save and continue the process.

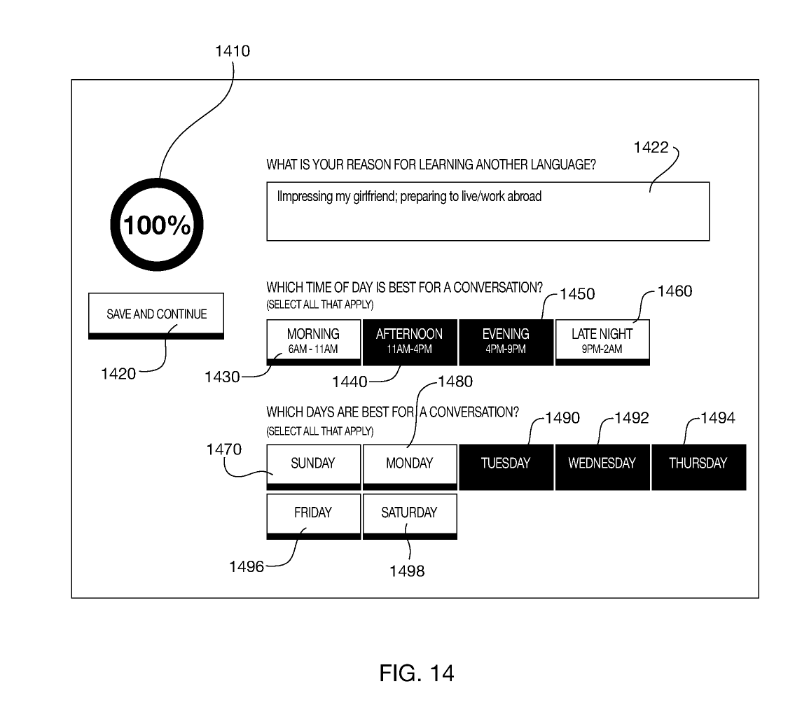

FIG. 14 shows a screen requesting a reason for the user's interest in second language acquisition. In text box 1422, the user indicates multiple reasons including impressing girlfriend, and preparing to live/work abroad. The same screen requests the user to indicate availability for conversation. Available time slots include, Morning 6 AM-11 AM (1430), Afternoon 11 AM-4 PM (1440), Evening 4 PM-9 PM (1450), and Late Night 9 PM-2 AM (1460). The user has selected afternoon and evening time slots. Below the portion of the screen daily requesting time of day preferences, the user may also provide day of week preference. Clearly, the days of the week comprise Sunday to Saturday (1470, 1480, 1490, 1492, 1494, 1496 and 1498). The user has selected Tuesdays, Wednesdays, and Thursdays. FIG. 14 also shows a completion circle graphic 1410 indicating 100% completion of the process. FIG. 14 also requests that the user save 1420 the on-ramp profile information and continue 1420 to log into the platform.

Under one embodiment, a specific field of profile information volunteered by a user in the on-ramp may be more heavily weighed than others as it relates to matching and/or “ice-breaker” content served to matched learners during a Boomalang brokered session. In other words, certain fields may command a greater importance/weight than others for determining matches or “ice-breaker” content.

Under one embodiment, the question fields may increase beyond those presented in FIGS. 10-14. Existing users may have the option to retroactively revise their profile information, as well. Furthermore, users who have completed the profile may receive new, mandatory additional questions under an embodiment. Responses are used to further refine the “ice-breaker” content and matching criteria as the Boomalang platform becomes more intelligent and highly personalized for each user.

### Audio Level Flow Moderator

In order to best capture and maximize the “flow” of conversation between two users, Boomalang provides a reactive tool that is dependent upon audio activity contributed by both matched users.

Effectively, the timing of the service of ice-breaker content to the two users is not randomized, nor fixed across all users' and their respective Boomalang conversations. Rather, new content/games are introduced to the users purely as a function of declined activity in their conversation, which is measured by an “Audio Level Flow Moderator,” measuring the frequency and volume of conversation between the two parties. The “Audio Level Flow Moderator” uses signal processing techniques to determine/analyze frequency components of conversationalists.

### Document Translation

In one embodiment, the two users can collaboratively negotiate the meaning of a “document” from one language to another. “Documents” can range in type of medium, type of content and difficulty level. For example, inclusive in the range documents are websites, personal documents, and advertisements. Boomalang may broker with third parties the receipt and posting of documents for translation. Alternatively, the platform may enable individual users to post material for translation. Platform users may then select content from posted material. Users may then translate such material during platform sessions and return the translation to the requesting party.

Under one embodiment, a user may upload a document for which a third party seeks translation. The user may collaboratively translate such document with a partner during a platform session as described herein.

Under one embodiment, the users are presented with a document via their video screen, and are asked to type the translation into the text box field located below the video. The users may collaboratively translate while a single user inputs the translation into the text box field. Alternatively, both users have access to the text box field.

Under one embodiment, the users are compensated by Boomalang or third parties for their translation services.

### Additional Games Considered for the Future

“Role-play”—Similar to many offline language-learning practices, each user is presented with a fictional role to fill as they act out a scenario. Under one embodiment, users are presented with on screen clickable/selectable answers. Alternatively, users verbally “play” or simply exchange information regarding the scenario with their match. Such conversion may comprise a free exchange of information without necessarily recording/cataloging any information.
“Family Feud”—Similar to the popular game show, the users are asked a question in view of survey results collected among one or both populations/cultures that are represented in the conversation. (Or potentially, populations/cultures outside of both represented parties). Under one embodiment, users are presented with on screen clickable/selectable answers. Alternatively, users verbally “play” or simply exchange information regarding such questions with their match. Such conversion may comprise a free exchange of information without necessarily recording/cataloging any information.
“Name that tune/artist”—A clip of a song and/or video may be served to the match where the users respond as quickly and accurately as possible. Under one embodiment, users are presented with on screen clickable/selectable answers.

Alternatively, users verbally “play” or simply exchange information regarding such song/video with their match. Such conversion may comprise a free exchange of information without necessarily recording/cataloging any information.

Under one embodiment, points may be collected by the users for their participation and “success” across many different game play metrics. These points may be reimbursed with rewards including access to additional benefits within the platform such as access to additional games or content.

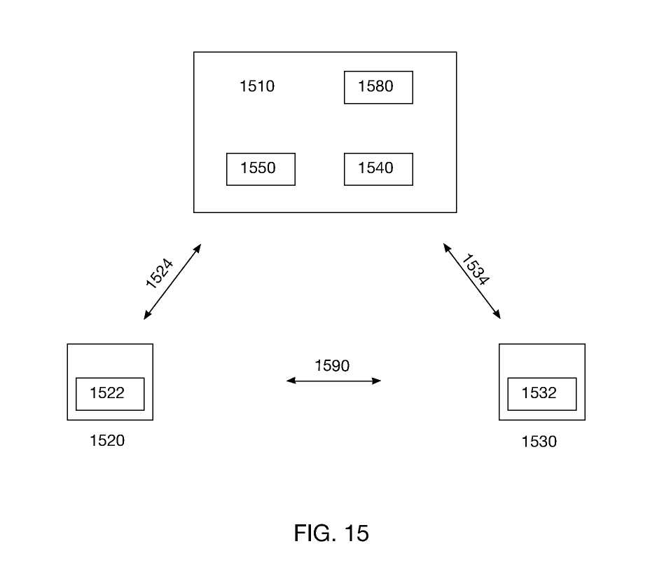

FIG. 15 shows mobile devices 1520, 1530 running client applications 1522, 1532. The client applications 1522, 1532 are communicatively coupled with one or more applications 1550 running on at least one processor 1540 of a remote server 1510 comprising memory 1580. The one or more applications match Boomalang users based on on-ramp profile data and provide a communications coupling 1590 between client applications to create a Boomalang communication session between corresponding users under an embodiment.

Under one embodiment, a method is described herein including a plurality of client applications providing an electronic interface for receiving personality information and conversation preference information of corresponding users, wherein each client application of the plurality of client applications runs on a corresponding computing platform. The method includes one or more applications running on a processor of a remote server receiving the personality information and conversation preference information from the plurality of client applications, the one or more applications using the personality information and conversation preference information to match a first user of a first client application with a second user of a second client application, wherein the plurality of client applications includes the first client application and the second client application. The method includes the one or more applications establishing a communications coupling between the first client application and the second client application, wherein the communications coupling comprises a communication session.

The corresponding computing platforms comprise one or more of a smartphone, tablet, laptop, and desktop computer under an embodiment.

The plurality of client applications under an embodiment comprise native applications for the corresponding computing platforms.

The plurality of client applications under an embodiment comprises at least one web based HTML application, wherein the corresponding computing platforms include web browser clients accessing the at least one HTML application.

The communication session under an embodiment comprises a conversation between a native speaker of a language and a non-native speaker of the language.

The personality information under an embodiment includes demographic data including gender, age and native language capability.

The personality information under an embodiment comprises culinary preferences.

The personality information under an embodiment comprises hobbies and activity preferences.

The personality information under an embodiment includes musical interests.

The personality information under an embodiment includes movie, television and literature preferences.

The conversation preference information under an embodiment includes target language interest, wherein target language interest comprises an interest in learning at least one selected target language.

The conversation preference information under an embodiment includes a proficiency level in the at least one selected target language.

The conversation preference information under an embodiment includes preferred daily times and days of week for scheduling the communication session.

The one or more applications under an embodiment select one or more of games and questions relating to first and second user personality information.

The one or more applications under an embodiment provide the one or more of the games and questions to the first user via the first client application and the second user via the second application during the communication session, the first user and the second user collaboratively engaging the one or more of the games and questions.

The one or more applications under an embodiment monitor at least one of a frequency and volume of conversation during the communication session.

The monitoring under an embodiment comprising detecting decreased conversational activity, the detecting the decreased conversation activity comprising the one or more applications providing the one or more of the games and questions.

The one or more applications under an embodiment providing content for translation to the first user via the first client application and the second user via the second application during the communication session.

The first user and the second user under an embodiment collaborate during the communication session to translate the content from a first language to a second language, wherein the first language is different than the second language.

The one or more applications under an embodiment archive at least one portion of the communication session.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The Boomalang platform can be a component of a single system, multiple systems, and/or geographically separate systems. The Boomalang platform can also be a subcomponent or subsystem of a single system, multiple systems, and/or geographically separate systems. The Boomalang platform components can be coupled to one or more other components (not shown) of a host system or a system coupled to the host system.

One or more components of the Boomalang platform and/or a corresponding interface, system or application to which the Boomalang platform is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include the Boomalang platform can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the Boomalang platform and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the Boomalang platform and corresponding systems and methods include: microcontrollers with memory (such as electronically erasable programmable read only memory (EEPROM)), embedded microprocessors, firmware, software, etc. Furthermore, aspects of the Boomalang platform and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the Boomalang platform and corresponding systems and methods is not intended to be exhaustive or to limit the systems and methods to the precise forms disclosed. While specific embodiments of, and examples for, the Boomalang platform and corresponding systems and methods are described herein for illustrative purposes, various equivalent modifications are possible within the scope of the systems and methods, as those skilled in the relevant art will recognize. The teachings of the Boomalang platform and corresponding systems and methods provided herein can be applied to other systems and methods, not only for the systems and methods described above.

The elements and acts of the various embodiments described above can be combined to provide further embodiments. These and other changes can be made to the Boomalang platform and corresponding systems and methods in light of the above detailed description.

What is claimed is:

1. A method comprising,
a plurality of client applications providing an electronic interface for receiving personality information and conversation preference information of corresponding users, wherein each client application of the plurality of client applications runs on a corresponding computing platform;
one or more applications running on a processor of a remote server receiving the personality information and conversation preference information from the plurality of client applications, the one or more applications using the personality information and conversation preference information to match a first user of a first client application with a second user of a second client application, wherein the plurality of client applications includes the first client application and the second client application;
the one or more applications establishing a communications coupling between the first client application and the second client application, wherein the communications coupling comprises a communication session.

2. The method of claim 1, wherein the corresponding computing platforms comprise one or more of a smartphone, tablet, laptop, and desktop computer.

3. The method of claim 1, wherein the plurality of client applications comprise native applications for the corresponding computing platforms.

4. The method of claim 1, wherein the plurality of client applications comprises at least one web based HTML application, wherein the corresponding computing platforms include web browser clients accessing the at least one HTML application.

5. The method of claim 1, wherein the communication session comprises a conversation between a native speaker of a language and a non-native speaker of the language.

6. The method of claim 1, wherein the personality information includes demographic data including gender, age and native language capability.

7. The method of claim 1, wherein the personality information comprises culinary preferences.

8. The method of claim 1, wherein the personality information comprises hobbies and activity preferences.

9. The method of claim 1, wherein the personality information includes musical interests.

10. The method of claim 1, wherein the personality information includes movie, television and literature preferences.

11. The method of claim 1, wherein the conversation preference information includes target language interest, wherein target language interest comprises an interest in learning at least one selected target language.

12. The method of claim 11, wherein the conversation preference information includes a proficiency level in the at least one selected target language.

13. The method of claim 1, wherein the conversation preference information includes preferred daily times and days of week for scheduling the communication session.

14. The method of claim 1, wherein the one or more applications select one or more of games and questions relating to first and second user personality information.

15. The method of claim 14, the one or more applications providing the one or more of the games and questions to the first user via the first client application and the second user via the second application during the communication session, the first user and the second user collaboratively engaging the one or more of the games and questions.

16. The method of claim 1, wherein the one or more applications monitor at least one of a frequency and volume of conversation during the communication session.

17. The method of claim 16, the monitoring comprising detecting decreased conversational activity, the detecting the decreased conversation activity comprising the one or more applications providing the one or more of the games and questions.

18. The method of claim 1, the one or more applications providing content for translation to the first user via the first client application and the second user via the second application during the communication session.

19. The method of claim 18, wherein the first user and the second user collaborate during the communication session to translate the content from a first language to a second language, wherein the first language is different than the second language.

20. The method of claim 1, wherein the one or more applications archive at least one portion of the communication session.
